(19) United States
(12) Patent Application Publication
(10) Pub. No.: US 2020/0138661 A1
(43) Pub. Date: May 7, 2020

(54) AUTOMATED PHYSICAL THERAPY SYSTEM FOR PROVIDING A RANGE OF MOTION EXERCISES FOR A USER

(71) Applicant: Mark Erb, Menomonie, WI (US)

(72) Inventor: Mark Erb, Menomonie, WI (US)

(21) Appl. No.: 16/734,809

(22) Filed: Jan. 6, 2020

Related U.S. Application Data
(63) Continuation-in-part of application No. 15/217,037, filed on Jul. 22, 2016, now Pat. No. 10,561,562.
Application No. 15/217,037 is a continuation-in-part of application No. 14/045,328, filed on Oct. 3, 2013, now abandoned.
Application No. 14/045,328 is a continuation-in-part of application No. 13/915,869, filed on Jun. 12, 2013, now abandoned.
Application No. 14/045,328 is a continuation-in-part of application No. 13/915,869, filed on Jun. 12, 2013, now abandoned.
Application No. 13/915,869 is a continuation-in-part of application No. 13/088,149, filed on Apr. 15, 2011, now Pat. No. 8,485,994.
(60) Provisional application No. 61/325,170, filed on Apr. 16, 2010.

(51) Int. Cl. A61H 1/02

(52) U.S. Cl. CPC A61H 1/0214; A61H 1/0274; A61H 1/0266; A61H 2201/1638; A61H 2001/0203; A61H 2201/1676; A61H 2201/1642; A61H 1/024; A61H 2201/1215

(57) ABSTRACT

An automated system used for physical therapy, more particularly a motorized pulley system of exercising a user's arms and legs at variable paddle cycles and variable paddle depths. The system utilizes a unique system of strings operatively looped through a pulley system and attached to a series of elongated components which are connected to a motor and which facilitate the movement of a user's arms and legs. The system of the present invention can provide users with increased mobility and enhanced circulation. The system may be useful for individuals recovering from an injury, individuals who are overweight, or individual with diabetes. The system may also be used for exercises to provide arm and leg extension and improve arm and leg strength.

### CROSS-REFERENCES TO RELATED APPLICATIONS

This application is a continuation-in-part and claims benefit of U.S. patent application Ser. No. 15/217,037 filed Jul. 22, 2016, which is a continuation-in-part and claims benefit of U.S. patent application Ser. No. 14/045,328 filed Oct. 3, 2013, which is a continuation-in-part and claims benefit of U.S. patent application Ser. No. 13/915,869 filed Jun. 12, 2013, which is a continuation-in-part and claims benefit of U.S. patent application Ser. No. 13/088,149 filed Apr. 15, 2011, now U.S. Pat. No. 8,485,994, which is a non-provisional and claims benefit of U.S. Provisional Patent Application 61/325,170 filed Apr. 16, 2010, the specification(s) of which is/are incorporated herein in their entirety by reference.

U.S. patent application Ser. No. 15/217,037 filed Jul. 22, 2016 is also a continuation-in-part and claims benefit of U.S. patent application Ser. No. 13/915,869 filed Jun. 12, 2013, which is a continuation-in-part and claims benefit of U.S. patent application Ser. No. 13/088,149 filed Apr. 15, 2011, now U.S. Pat. No. 8,485,994, which is a non-provisional and claims benefit of U.S. Provisional Patent Application 61/325,170 filed Apr. 16, 2010, the specification(s) of which is/are incorporated herein in their entirety by reference.

### BACKGROUND OF THE INVENTION

### Field of the Invention

The present invention relates to automated devices used for physical therapy, more particularly to a motorized pulley system of exercising a user's arms and legs at variable paddle cycles and variable paddle depths. More particularly, the system utilizes a series of strings operatively looped through a pulley system and attached to a series of elongated components which are connected to a motor to automatically facilitate the movement of a user's arms and legs.

### Description of Related Art Including Information Disclosed

Many individuals who have suffered injuries require physical therapy to aid their recovery. Devices have been invented that simulate activities such as simple movements, walking, and the like. The present invention features an automated physical therapy system providing a range of motion exercises for the arms and the legs of a user utilizing a motorized pulley system. When the system is activated, a series of elongated components allow for the movement of the user's arms and legs. The system of the present invention can be adjusted to provide variable paddle cycle and variable paddle depth to meet the individual rehabilitation needs of the user.

### BRIEF SUMMARY OF THE INVENTION

It is an objective of the present invention to provide a motorized pulley system that allows for automated physical therapy of a user's arms and legs, as specified in the independent claims. Embodiments of the invention are given in the dependent claims. Embodiments of the present invention can be freely combined with each other if they are not mutually exclusive.

The present invention provides users with increased mobility and enhanced circulation. The system may be useful for individuals recovering from an injury, individuals who are overweight, or individual with diabetes. The system may also be used for exercises to provide arm and leg extension and improve arm and leg strength.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

This patent application contains at least one drawing executed in color. Copies of this patent or patent application publication with color drawing(s) will be provided by the office upon request and payment of the necessary fee.

The features and advantages of the present invention will become apparent from a consideration of the following detailed description presented in connection with the accompanying drawings in which:

FIG. 1 shows a side perspective view of the exterior of the present invention.

FIG. 2 shows a side perspective view of the peddle system of the present invention.

FIG. 3A shows the drive mechanism of the present invention.

FIGS. 3B and 3C show the side perspective view of the duplicate exterior of the present invention.

FIGS. 4A and 4B show a side perspective of the variable paddle cycle system of the present invention.

FIG. 5 shows a side perspective of the variable paddle depth system of the present invention.

### DETAILED DESCRIPTION OF THE INVENTION

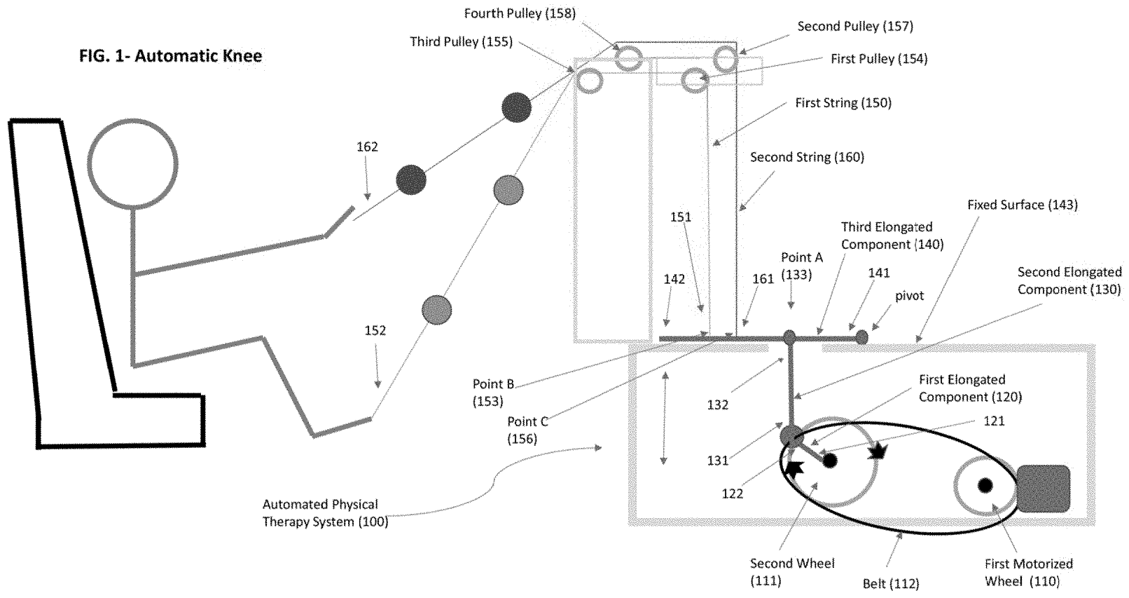

Referring to FIG. 1, the present invention features an automated physical therapy system (100) for providing a range of motion exercises for a user. In some embodiments the automated physical therapy system (100) comprises: a first motorized wheel (110); a second wheel (111) operatively connected to the first motorized wheel (110) via a belt (112), wherein the rotation of the first motorized wheel (110) drives the rotation of the second wheel (111) via the belt (112); a first elongated component (120) having a first proximal end (121) and a first distal end (122), wherein the first proximal end (121) of the first elongated component (120) fixedly attaches to the second wheel (111) at a center of the second wheel (111), wherein the rotation of the second wheel (111) spins the first elongated component (120) about the center of the second wheel (111); a second elongated component (130) having a second proximal end (131) and a second distal end (132), wherein the second proximal end (131) of the second elongated component (130) pivotably connects to the first distal end (122) of the first elongated component (120); a third elongated component (140) having a third proximal end (141) and a third distal end (142), wherein the third proximal end (141) of the third elongated component (140) is pivotably attached to a fixed surface (143); and a first string (150) with a first proximal end (151) and a first distal end (152), wherein the first proximal end (151) of the first string (150) is fixedly attached to the third elongated component (140) at a point B (153) located between the third distal end (142) of the third elongated component (140) and point A (133).

The second distal end (132) of the second elongated component (130) pivotably connects to a point A (133), wherein point A is located between the third proximal end (141) of the third elongated component (140) and the third distal end (142) of the third elongated component (140). The first string (150) is operatively looped around a first pulley (154) and a third pulley (155). The first distal end (152) of the first string (150) is used for attachment to a first foot of the user.

In some embodiments, the system (100) further comprises a second string (160) with a second proximal end (161) and a second distal end (162), wherein the second proximal end (161) of the second string (160) is operatively attached to the third elongated component (140) at a point C (156) located between the third distal end (142) of the third elongated component (140) and point A (133). The second string (160) is operatively looped around a second pulley (157) and a fourth pulley (158). The second distal end (162) of the second string (160) is used for attachment to a first arm of the user.

In some embodiments, the system (100) further comprises a first motorized wheel (110) that is controlled by an electronic control mechanism and may be operated by remote control by the use of a handheld device, including but not limited to a cellular phone.

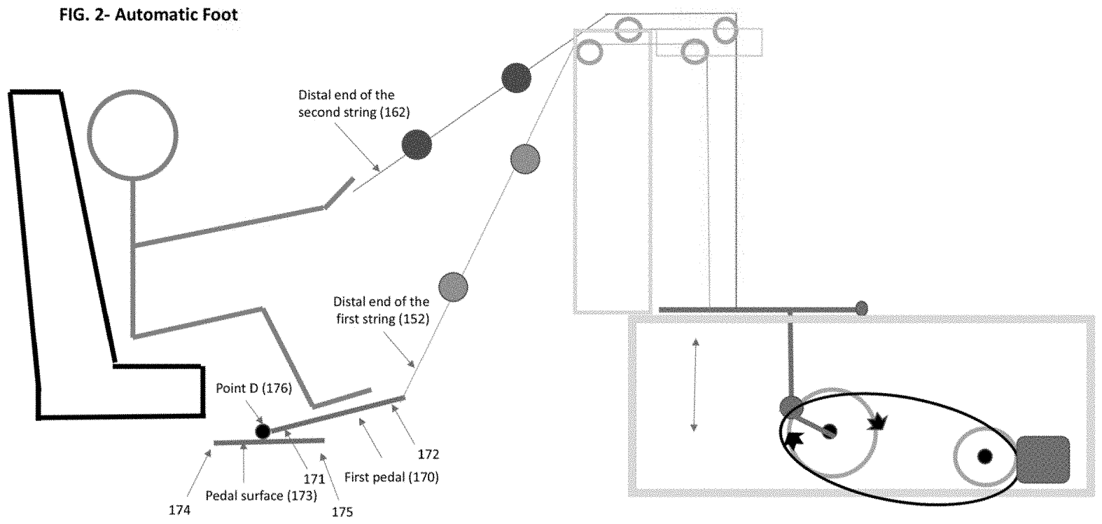

Referring to FIG. 2, the present invention features a first pedal (170) with a first proximal end (171) and a first distal end (172) and a pedal surface (173) with a first proximal end (174) and a first distal end (175). The first proximal end (171) of the first pedal (170) is pivotably attached to the pedal surface (173) at a point D (176) located between the first proximal end (174) and the first distal end (175) of the pedal surface (173). The first distal end (172) of the first pedal (170) is fixedly attached to the first distal end (152) of the first string (150).

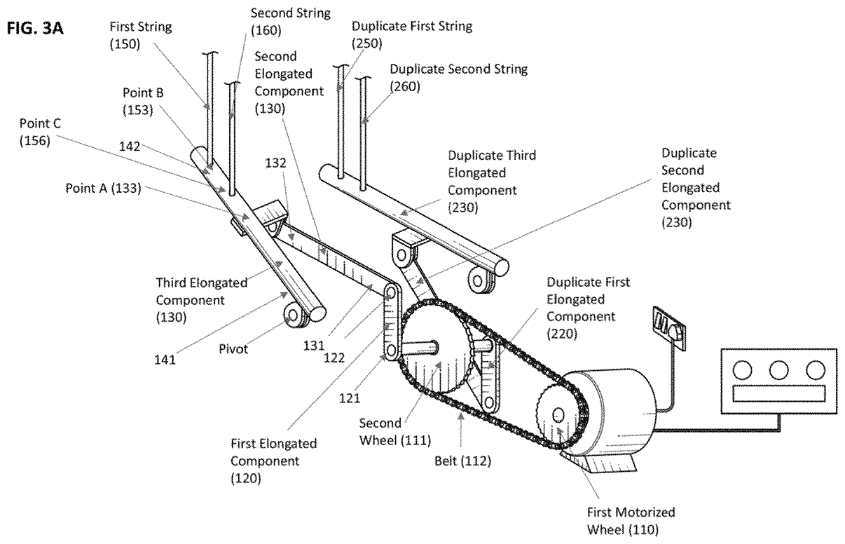

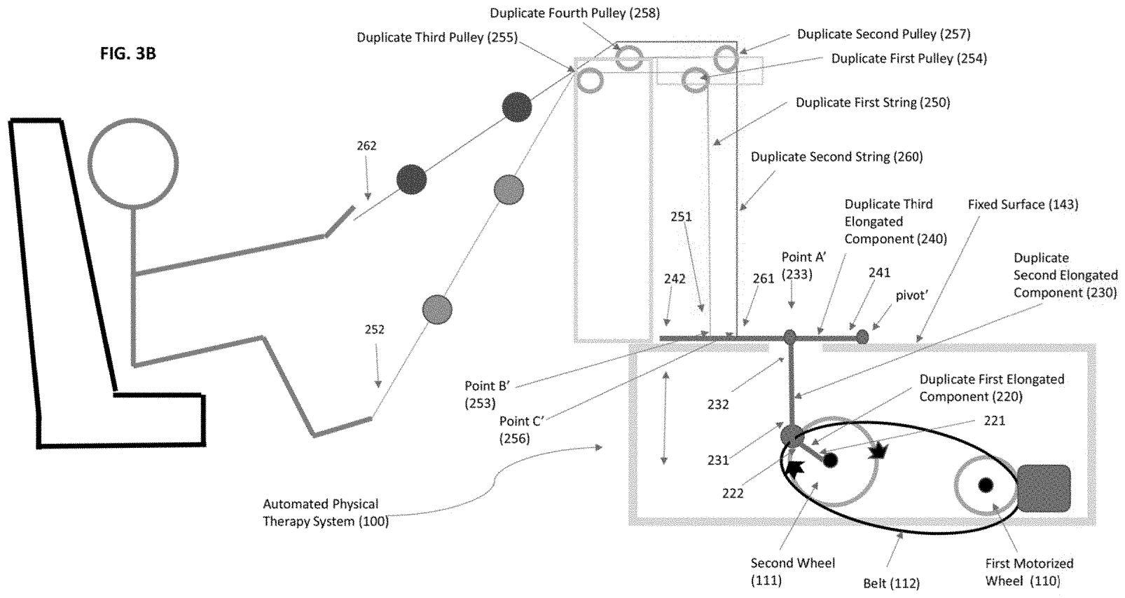

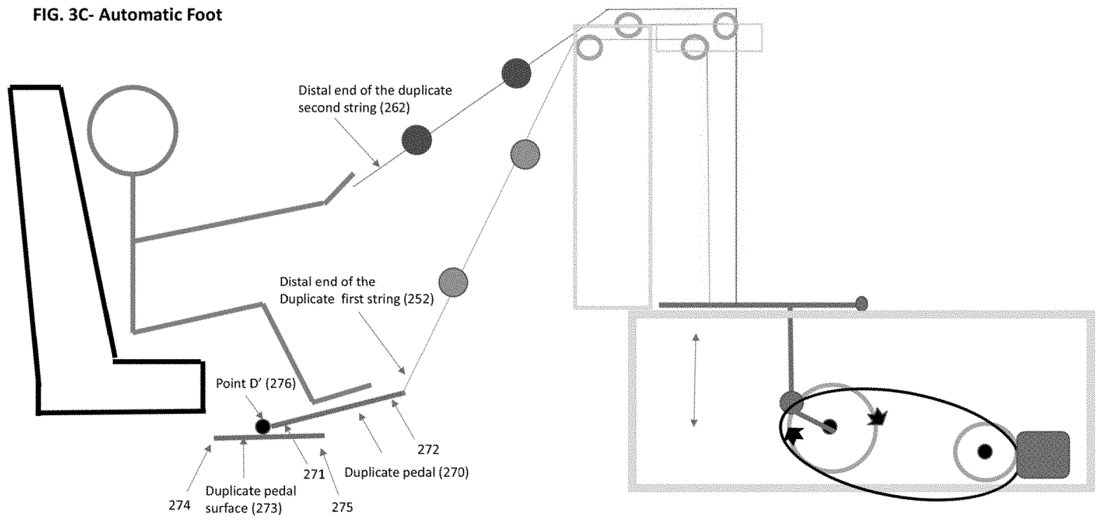

Referring to FIG. 3A, the present invention features a duplicate first elongated component (220), a duplicate second elongated component (230), a duplicate third elongated component (240), and a duplicate first string (250). The duplicate parts are arranged in the same way as described in claim 1.

Referring to FIG. 3B, the present invention additionally features a duplicate first pulley (254) and a duplicate third pulley (212). The duplicate first string (210) is operatively looped around the duplicate first pulley (255) and the duplicate third pulley (221). The distal end (211) of the duplicate first string (210) is used for attachment to a second foot of the user.

In some embodiments, the system further comprises a duplicate second string (260), a duplicate second pulley (257) and a duplicate fourth pulley (258). The duplicate parts are arranged in the same way as described in claim 1. The duplicate second string (210) is used for attachment to a second arm of the user.

Referring to FIG. 3C, the present invention features a duplicate first pedal (230) and the duplicate pedal surface (240) wherein the distal end (232) of the duplicate first pedal (230) is fixedly attached to the duplicate first string (210).

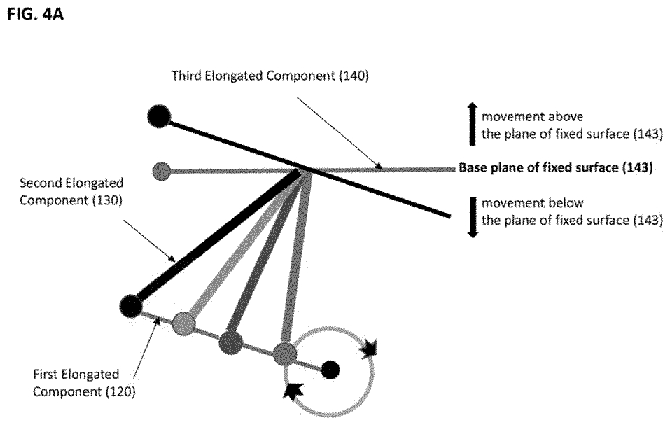

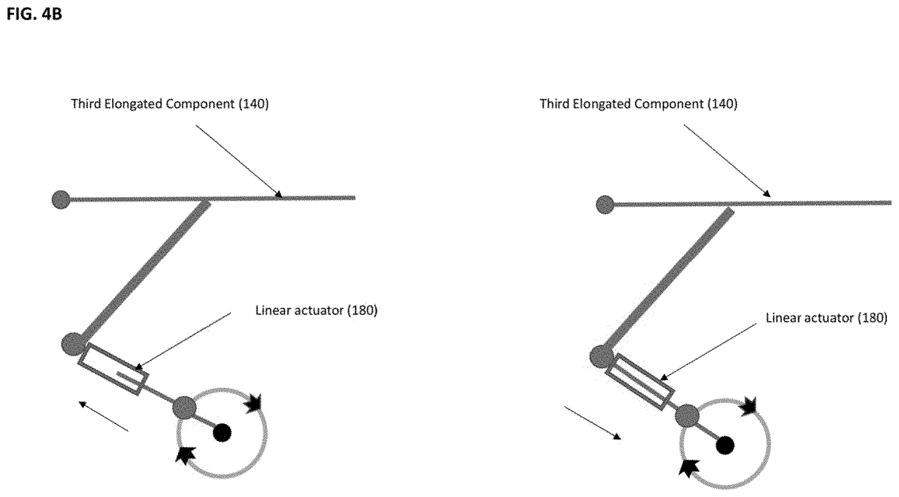

Referring to FIGS. 4A and 4B, the present invention features the first elongated component (120) having variable paddle cycle; variable paddle cycle being defined as the ability of the first elongated component (120) and the second elongated component (130) to be displaced at various heights above and below the plane of the fixed surface (143). Said height can be adjusted by moving the connection point of the second proximal end (131) of the second elongated component (130) along the first distal end (122) of the first elongated component (120).

In some embodiments, a series of first apertures on the first elongated component (120) and pins are used for variable paddle cycle. The distance of the first apertures along the first elongated component (120) can be adjusted to create varying paddle cycle.

In some embodiments, a linear actuator system (180) is used for variable paddle cycle. The linear actuator system (180) may include a piston system.

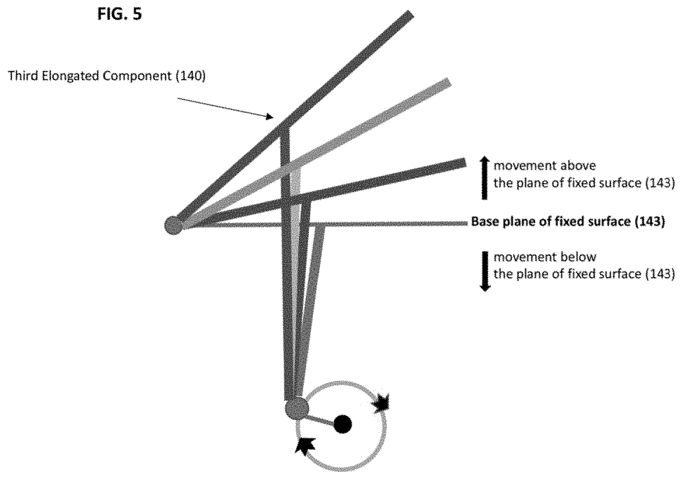

Referring to FIG. 5, the present invention features the second elongated component (130) having variable paddle depth; variable paddle depth being defined as the ability of the first elongated component (120) and the second elongated component (130) to be displaced at various angles above and below the plane of the fixed surface (143). Said angle can be adjusted by moving the connection point of the first distal end (122) of the first elongated component (120) along the second proximal end (131) of the second elongated component (130).

In some embodiments, a series of second apertures on the second elongated component (130) and pins are used for variable paddle cycle. The distance of the second apertures along the second elongated component (130) can be adjusted to create varying paddle depth.

In some embodiments, a linear actuator system (180) is used for variable paddle cycle. The linear actuator system (180) may include a piston system.

What is claimed is:

1. An automated physical therapy system (100) providing range of motion exercises for a user, wherein the automated physical therapy system (100) comprises:
(a) a first motorized wheel (110);
(b) a second wheel (111) operatively connected to the first motorized wheel (110) via a belt (112), wherein the rotation of the first motorized wheel (110) drives the rotation of the second wheel (111) via the belt (112);
(c) a first elongated component (120) having a first proximal end (121) and a first distal end (122), wherein the first proximal end (121) of the first elongated component (120) fixedly attaches to the second wheel (111) at a center of the second wheel (111), wherein the rotation of the second wheel (111) spins the first elongated component (120) about the center of the second wheel (111);
(d) a second elongated component (130) having a second proximal end (131) and a second distal end (132), wherein the second proximal end (131) of the second elongated component (130) pivotably connects to the first distal end (122) of the first elongated component (120);
(e) a third elongated component (140) having a third proximal end (141) and a third distal end (142), wherein the third proximal end (141) of the third elongated component (140) is pivotably attached to a fixed surface (143);
wherein the second distal end (132) of the second elongated component (130) pivotably connects to a point A (133), wherein point A is located between the third proximal end (141) of the third elongated component (140) and the third distal end (142) of the third elongated component (140);
(f) a first string (150) with a first proximal end (151) and a first distal end (152), wherein the first proximal end (151) of the first string (150) is fixedly attached to the third elongated component (140) at a point B (153) located between the third distal end (142) of the third elongated component (140) and point A (133);
wherein the first string (150) is operatively looped around a first pulley (154) and a third pulley (155).

2. The system (100) of claim 1, further comprising:
(a) a second string (160) with a second proximal end (161) and a second distal end (162), wherein the second proximal end (161) of the second string (160) is operatively attached to the third elongated component (140) at a point C (156) located between the third distal end (142) of the third elongated component (140) and point A (133);
wherein the second string (160) is operatively looped around a second pulley (157) and a fourth pulley (158);
wherein the second distal end (162) of the second string (160) is used for attachment to a first arm of the user.

3. The system (100) of claim 1, wherein the first distal end (152) of the first string (150) is used for attachment to a first foot of the user.

4. The system (100) of claim 1, further comprising:
(a) a pedal (170) with a first proximal end (171) and a first distal end (172);
(b) a pedal surface (173) with a first proximal end (174) and a first distal end (175);
wherein the first proximal end (171) of the pedal (170) is pivotably attached to the pedal surface (173) at a point D (176) located between the first proximal end (174) and the first distal end (175) of the pedal surface (173);
wherein the first distal end (172) of the pedal (170) is fixedly attached to the first distal end (152) of the first string (150).

5. The system (100) of claim 1, further comprising:
(a) a duplicate first elongated component (220), a duplicate second elongated component (230), a duplicate third elongated component (240), a duplicate first string (250), a duplicate first pulley (254) and a duplicate third pulley (255);
wherein the duplicate first string (250) is operatively looped around the duplicate first pulley (254) and the duplicate third pulley (255).
